(19) United States
(12) Patent Application Publication
(10) Pub. No.: US 2001/0024634 A1
(43) Pub. Date: Sep. 27, 2001

(54) Method of producing hydrogen peroxide by direct synthesis and noble-metal catalyst for the method

(76) Inventors: Birgit Bertsch-Frank, Wuppertal (DE); Ina Hemme, Hanau (DE); Jurgen Rollmann, Pflaumheim (DE); Stipan Katusic, Kelkheim (DE); Torsten Balduf, Hanau (DE); Catrin D. Becker, Frankfurt (DE); Werner Wildner, Seligenstadt (DE); Rudiger Schutte, Alzenau (DE)

Correspondence Address: PILLSBURY WINTHROP LLP, 1600 TYSONS BOULEVARD, MCLEAN, VA, 22102, US

(21) Appl. No.: 09/792,064

(22) Filed: Feb. 26, 2001

(30) Foreign Application Priority Data
Feb. 26, 2000 (DE) 100 09 187.3

(51) Int. Cl. C01B 15/029; B01J 27/13; B01J 27/06

(52) U.S. Cl. 423/584; 502/229; 502/224

(57) ABSTRACT

The invention is relative to a method of producing hydrogen peroxide by direct synthesis in which hydrogen and oxygen are reacted in the presence of a heterogeneous, carrier-free or carrier-bound catalyst containing at least one noble metal in the presence or absence of a solvent and to a catalyst for carrying out the method.

The use of a halide promoter and/or of a mineral acid can be avoided by using a noble-metal catalyst containing an inorganic iodine compound in an amount corresponding to 0.01 to 15% by weight iodine relative to the noble-metal content.

### CROSS-REFERENCE TO RELATED APPLICATION

This application claims priority from German Application No. 10009187.3, filed on Feb. 26, 2000, the complete disclosure of which is hereby incorporated herein by reference.

### BACKGROUND OF THE INVENTION

1. Field of Invention

The present invention relates to a method for producing hydrogen peroxide by direct synthesis from hydrogen and oxygen in the presence of a heterogeneous catalyst comprising at least one noble metal, preferably palladium, and a promoter in the presence or absence of a solvent. The use of a catalyst in accordance with the present invention renders superfluous the continuous use of a halide [halogenide] promoter in an aqueous or gaseous reaction phase. The invention also concerns a catalyst suitable for carrying out the method.

2. Background

It is well known that hydrogen peroxide can be obtained by direct synthesis by reacting hydrogen with oxygen in an acidic aqueous medium, in the presence of a noble-metal carrier catalyst such as Pd on activated carbon or other heterogeneous catalysts containing Pd and/or Pt. See EP-B 0 274 830. In this known method, an aqueous reaction medium is used wherein a mineral acid is used for the purpose of inhibiting the decomposition of formed hydrogen peroxide. The selectivity is increased by adding a bromide promoter. This known method has various problems including a low selectivity and/or low achievable concentration of H₂O₂, and/or a low space-time yield. Furthermore, in some instances, a high discharging of catalyst is required, thereby the technical expense for recovering the catalyst increases and the H₂ selectivity decreases, with increasing processing time. Additionally, this known method necessitates separating the acid and the promoter from the aqueous solution of hydrogen peroxide obtained, in order to obtain a marketable solution of H₂O₂.

In the method according to EP-A 0 366 419, a gaseous mixture containing H₂ and O₂ is passed over a catalytic bed arranged in a trickle-bed reactor while at the same time an aqueous phase containing H₂SO₄ and HCl trickles cocurrently over the catalytic bed. A high selectivity is obtained in this method using a noble metal catalyst bound on a hydrophobic carrier, under the usual conditions of pressure and temperature. However, this selectivity has the disadvantage of a very low concentration of H₂O₂ (0.15 to 0.3%) thus produced. In addition to the expense incurred for further concentration, there is also the expense of separating HCl and H₂O₂ from the aqueous solution of H₂O_{2.}

EP-A 0 579 109 teaches a similar trickle-bed method. A high selectivity is achieved by maintaining a certain volumetric ratio of the gaseous phase to the liquid phase. WO 99/52820 teaches solutions with a high concentration of H₂O₂ by charging the reaction gas mixture with water vapor. Solutions of H₂O₂ containing bromide and sulfuric acid are also obtained in these methods.

The concentration of acid and bromide used in the liquid reaction medium were lowered by using a catalyst containing a palladium/gold alloy in accordance with DE-A 41 27 918; however, both palladium/gold alloy had to be present.

In the method according to EP-B 0 504 741, the liquid reaction medium contains a halogen-containing activator and, additionally as an option, may contain a stabilizer for hydrogen peroxide without the acid. In this instance the noble-metal catalyst is located on a solid superacid carrier.

In contrast thereto, EP-B 0 492 064 teaches a direct synthesis without the continuous addition of an acid and of a bromide promoter to an aqueous reaction medium. This succeeds by using a platinum group metallic catalyst on a halogenated resin such as a brominated styrene divinylbenzene copolymer. The aqueous reaction medium can contain a conventional stabilizer for hydrogen peroxide.

An alternative to the method of EP-B 0 292 064 is taught by EP-B 0 498 166. In EP 0498 166, the metallic or carrier-bound catalyst contains a water-insoluble, organic compound of chlorine, bromine or iodine such as bromobenzene or iodobenzene or a chloroalkylsilane compound, bound to the carrier material such as SiO₂. The aqueous reaction medium is again free of strong acids and promoters and preferably contains only a [one] stabilizer for hydrogen peroxide in conventional concentration.

### SUMMARY OF THE INVENTION

In one embodiment of the present invention, the invention overcomes the problem of having to supply a mineral acid and/or a halide promoter to the aqueous reaction medium or reaction gas, for the direct synthesis of hydrogen peroxide in the presence of an iodine-containing noble-metal catalyst. In a second embodiment of the present invention, the invention addresses a problem which concerns the availablity of a noble-metal catalyst suitable for said synthesis as well as a method of producing the catalyst, to be used in accordance with the invention.

The above-mentioned problems are solved by the method in accordance with the invention, for the production of hydrogen peroxide and by the iodine-containing noble-metal catalysts and by method of their production in accordance with the main claims.

Accordingly, the invention describes a method for producing hydrogen peroxide by direct synthesis comprising reacting hydrogen and oxygen in the presence of a heterogeneous, carrier-free or carrier-bound catalyst containing at least one noble metal and one iodine compound, in the presence or the absence of a solvent, wherein iodine content in said catalyst is in range of 0.01 to 15%, based on the noble metal content.

### DESCRIPTION OF PREFERRED EMBODIMENTS

The carrier-free or carrier-bound noble metal catalyst in the present invention contains at least one noble metal and one iodine compound wherein content of an inorganic iodine compound corresponds to 0.01 to 15% by weight relative to the noble metal content. Such a catalyst is especially suitable for carrying out the direct synthesis of H₂O₂.

The catalyst is generally present in the form of catalytic particles (=carrier-free) that can also be bound to a customary carrier. The catalytically active component contains one or several noble metals in pure form or in the form of alloys. Preferred noble metals are the platinum metals, especially palladium and platinum, as well as gold and silver. It is especially preferred that the catalytic particles contain at least 80% by weight palladium, 0 to 15% by weight gold and/or 0 to 15% platinum and 0 to 5% by weight silver in alloyed or non-alloyed form as well as an iodide of one or several of the elements of the series Pd, Pt, Au and Ag in an amount of 0.1 to 10% by weight iodine.

An essential component of the catalyst is the presence of an inorganic iodine compound that is located on the particles of noble metal or of a noble-metal alloy and/or is preferably inserted in these particles uniformly or close to the surface. The iodine compound used in direct synthesis is either advantageously slightly soluble or preferably substantially insoluble in water or in an aqueous reaction medium. The slightly soluble to insoluble iodine compounds noble-metal iodides are preferred. As shown from Electron spin resonance (ESR) spectra, the palladium iodides that are especially preferably present, in addition to PdI₂ even palladium iodides with another Pd/I ratio are catalytically active. The inorganic iodine compounds bound in the catalyst obviously assume the function of a promoter.

The iodine content can be in a range of 0. 01 to 15% by weight relative to the noble-metal content. However, an iodine content in a range of 0.1 to 10% by weight, is preferable. Carrier-free, iodine-containing noble-metal catalysts whose production preferably comprises a spray or flame pyrolysis and iodine-containing noble-metal catalysts, subsequently bound to carriers in a conventional manner, are suitable for the purpose under consideration here, in the direct synthesis of H₂O₂. Suitable examples of carriers are activated carbon, metal oxides such as SiO₂, Al₂O₃, ZrO₂, TiO₂ and silicates, including preferably those that have a zeolite structure.

In a preferred embodiment, a catalyst used was produced by a spray or flame pyrolysis method comprising: (i) the producing of a gas-carried particle collective containing one or more components from the series of a compound of the at least one noble metal and of an iodine compound in the particles, (ii) pyrolyzing of the particle collective in a spray or flame pyrolysis reactor at a temperature of 500 to 1500° C., (iii) separating solid particles formed from the gas flow and, if required, (iv) impregnating of a customary catalytic carrier with catalytic particles produced according to steps (i) to (iii).

The carrier-bound catalysts can be obtained either by in-situ production of the carrier material, in conjunction with the application of the noble metal(s) and iodine compound or in a known production manner, in which the carrier is impregnated with particles of the catalytically active, iodine-containing noble-metal systems and fixed, if needed, by a binder. The use of in-situ production of an oxidic or silicatic carrier is preferred. Strongly acidic carriers, such as molecular sieves of the ZSM type are especially preferred.

The direct synthesis for producing H₂O₂ can be carried out by different methods. The catalyst can be used as a suspension catalyst, preferably as a fixed-bed catalyst. In order to use the catalyst of the invention, as a fixed-bed catalyst, it is converted in a known manner into suitable molded blanks such as tablets, granulates, extrudates and the like. Preferably, fixed-bed catalyst is operated in the trickle-bed manner, such that an aqueous reaction medium trickles over the fixed bed in cocurrent or countercurrent to a gaseous mixture containing hydrogen and oxygen. Alternatively, a gaseous mixture saturated with water vapor and containing H₂ and O₂ is supplied, at the top to the fixed-bed reactor and the condensation of an aqueous solution of H₂O₂ does not occur until in the lower part of the reactor. The volumetric ratio of the gas flow to the liquid, supplied or removed at the bottom of the reactor can be within broad limits; this follows from the embodiments according to EP-A 0 579 109 and WO 99/52820, the disclosed content of which is included in the present specification.

The present invention is distinct from many previously known methods such that halide promoter is not used and, aside from any optional acidic H₂O₂ stabilizers, mineral acid is not added to a reaction medium in the invention. It is advantageous to add one or several conventional stabilizers for hydrogen peroxide in a conventional amount, that is, in a total amount of less than 1000 mg/I, in particular less than 500 mg/l to the medium. Suitable stabilizers are, e.g., phosphates, pyrophosphates, phosphonates and their underlying [basic] acids and stannates.

The direct synthesis normally takes place at approximately 20° C. to approximately 70° C., preferably at 40 to 60° C. at a pressure of approximately 0.1 to 10 MPa, especially 1 to 5 MPa.

According to a preferred embodiment, the production of the catalysts comprises a spray or flame pyrolysis method. The production of the particle collective (=stage (i)) takes place by spraying one or several solutions of compounds of the catalyst-forming elements. Noble metals are preferred in the form of nitrates, and the iodine compound in the form of noble-metal iodides. The preferred spraying method takes place by the formation of aerosol by means of multicomponent nozzles or ultrasonic aerosolizers [atomizers]. According to a preferred embodiment, the aerosol is predried before entering into the reactor. Details concerning the production of the aerosol, the predrying and the flame reactor can be gathered from DE-OS 195 45 455 and DE patent 196 47 038. The aerosol of the iodine compound, can form a particle collective with that of the noble-metal compound(s) or is supplied separately to the reactor, e.g., at a position with an already reduced temperature such as 500 to 800° C. The temperature in the reactor is preferably in a range of 500 to 1100° C.

By analogy to the spray pyrolysis method according to DE-OS 43 07 333, fine, catalytically active particles can be obtained when using solutions of noble-metal compounds and an iodine compound, instead of the metal compounds cited herein.

In order to produce carrier-bound catalysts with an oxidic or silicatic catalyst, the gas-carried particle collective additionally contains one or several precursors required for the formation of the carrier, in the form of a form soluble in a solvent. Refer to DE-OS 196 47 038, regarding details for carrying out the method of producing the catalyst. The method of the present invention differs from the previously known method in that, a solution of an iodine compound is additionally converted separately, or together with other components of the system, into spray droplets or an aerosol and therefore becomes a component of the particle collective supplied to the reactor.

The preferred production of the novel catalysts in the present invention, comprises a flame pyrolysis method, was discussed previously. According to a further embodiment, at first carrier-free or carrier-bound, iodine-free noble-metal particles are produced by a spray or flame pyrolysis method. The iodization then takes place in a subsequent stage upon contacting an iodide solution, such as an alkali- or noble-metal iodide solution at room temperature or especially at an elevated temperature such as 40 to 90° C. Surprisingly, iodide is inserted from e.g., sodium iodide, into the noble metal particles and formation of a noble-metal iodide can be demonstrated by ESR. After the contacting, non-bound iodide is washed out.

Additional advantages of the present invention are the usability and high efficiency of the novel, iodine-containing noble-metal catalysts, in the direct synthesis of hydrogen peroxide. The use of a promoter and/or of a mineral acid can thereby be avoided. The catalysts can be obtained in a simple manner analogous to previously known oxidic or silicatic carrier catalysts, containing noble-metal powders or noble-metal particles such that an iodine compound is additionally used in the framework of a spray or flame pyrolysis method or by a simple post-treatment of iodine-free noble-metal particles with an iodide solution.

The invention is further explained using the non-limiting production and examples for the production of the catalysts and their use in direct synthesis for the production of H₂O₂ as well as comparative examples.

Production Alternative 1

Alternative for the Production of the Catalytically Active Component

An aqueous solution of the noble-metal salt(s), especially of the chlorides or nitrates, in a total concentration of approximately 2.5 to 10% by weight, is atomized by an ultrasonic atomizer, ultrasonic aerosol generator or two-fluid nozzle. The drops produced are conducted into the reactor with the aid of a carrier gas.

Reactor length: 1000 mm, average width: 125 mm, aerosol nozzle in the reactor: d=46 mm, H₂ ring nozzle of 52 to 54 mm, air ring nozzle from 61 to 80 mm. The reactor contains 3 temperature-sensing probes. H₂ is used as burner gas (H₂-air flame: Tₘₐₓ=2045° C.).

For the preparation of the alloys, the temperatures in the reactor is still below the melting point of these products in a temperature range of 900 to 1100° C. at measuring point 1. Thereafter, the temperature in the flame reactor, up to measuring point 3, can drop down to 600° C.

When using the ultrasonic aerosol generator, the aerosol is conducted with the carrier gas, through a droplet trap and the drops with a diameter >10 μm are recycled. The aerosol passes thereafter into a predrying in which it is thermally treated, during which the temperature is between 80 and 300° C. and the dwell time between 1 and 20 seconds.

The product produced in the reactor is separated from the gas flow by filter.

Production Alternative 2

An aerosol is produced according to the same method as in Production Alternative 1, by an ultrasonic aerosol generator. Directly behind the droplet trap, an opening is located in the predrying stage, through which opening an inorganic iodine compound, preferably a noble-metal iodine compound, is supplied by carrier gas with the aid of a further atomizing unit. The aqueous solution of the iodine compound is dosed in such a manner that the desired percentage amount of iodine is achieved in the catalytic particles. The remaining method corresponds to Production Alternative 1.

Production Alternative 3

The method in Production Alternative 3 is the same in Production Alternative 1 except for differences noted below.

A two-fluid nozzle or an ultrasonic atomizer is used in order to apply an iodine compound onto the noble metal. An atomizing unit is connected approximately 15 cm below the reactor input through which unit the appropriate saline solution is supplied. The remaining method is similar to Production Alternative 1.

Production Alternative 4

Production Alternative 1 is modified in a manner such that noble-metal salt(s) and the appropriate iodine compound(s) are dissolved and aerosolized or atomized together. The remaining method is similar to Production Alternative 1.

Production Alternative 5

A catalyst produced according to Production Alternative 1 is treated here with an iodide-containing solution.

Production Alternative 6

Production of carrier-bound catalysts (general formula).

The noble-metal powders are suspended in a solution (H₂O organic solvent) for application onto the carrier; a molded article consisting of an oxidic carrier material is then impregnated. In order to evaporate the solvent the impregnated molded article is heated in an oven for 2 hours at first at 150° C. and then a further hour at 300° C.; calcination is then performed if indicated. The carrier material was present in the form of a spherical granulate with a grain diameter in the range of substantially 0.15 to 0.25 mm.

### COMPARATIVE EXAMPLE 1

Production of a Pd/Pt catalyst according to Example 1, except the catalyst is not in accordance with invention.

Solution used: Nitrate-acidic, Pd- and Pt-containing, aqueous solution (pH=1-3); noble-metal content 6% by weight of which 0.6% by weight Pt and 5.4% by weight Pd.

Method parameters:

| Predrying temperature: | 150° C. |
|---|---|
| Fuel gas (H₂): | 1600 l/h |
| Total amount of gas: | 4300 l/h reactor gas + |
| | 1200 l/h quenching gas |
| Lambda (O₂/H₂): | 1.4 |
| Powder composition: | 10% by weight Pt; 90% by weight Pd |
| Average grain size (Cilas ₅₀): | 0.45 μm |
| BET surface (m²/g): | 2.1 |

### EXAMPLE 1

Solutions used: Nitrate-acidic, Pd- and Pt-containing, aqueous solution (pH=1-3); noble-metal content 6% by weight.

Aqueous PdI₂ solution; 1% by weight relative to I₂; the dosage is adjusted for the desired iodine content.

Method parameters (Production Alternative 2):

| Predrying temperature: | 150° C. |
|---|---|
| Fuel gas (H₂): | 1400 l/h |
| Total amount of gas: | 5400 l/h reactor gas |
| Lambda (O₂/H₂): | 1.4 |
| Powder composition: | 10% by weight Pt; 88% by weight Pd; |
| | 2% by weight iodine as PdI₂ |
| Average grain size (Cilas ₅₀): | 1.82 μm |
| BET surface (m²/g): | 2.0 |

### EXAMPLE 2

Solutions used: Nitrate-acidic, Pd- and Pt-containing, aqueous solution (pH=1-3); noble-metal content 6% by weight.

Aqueous PdI₂ solution; 0.1% by weight relative to I₂; the dosage is adjusted for the desired iodine content.

Method parameters (Production Alternative 2):

| Predrying temperature: | 150° C. |
|---|---|
| Fuel gas (H₂): | 1400 l/h |
| Total amount of gas: | 5450 l/h reactor gas (including carrier gas |
| | for both aerosolizing units) |
| Lambda (O₂/H₂): | 1.4 |
| Powder composition: | 10% by weight Pt; 89.75% by weight Pd; |
| | 0.25% by weight iodine as PdI₂ |
| Average grain size (Cilas ₅₀): | 1.2 μm |
| BET surface (m²/g): | 1.5 (± 0.2) |

### EXAMPLE 3

Solutions used: Nitrate-acidic, Pd- and Pt-containing, aqueous solution (pH 1-3); noble-metal content 6% by weight

Aqueous PdI₂ solution; 0.4% by weight relative to I₂; the dosage is adjusted for the desired iodine content.

Method parameters (Production Alternative 2):

| Predrying temperature: | 150° C. |
|---|---|
| Fuel gas (H₂): | 1400 l/h |
| Total amount of gas: | 5400 l/h reactor gas (including carrier gas |
| | for both aerosolizing units) |
| Lambda (O₂/H₂): | 1.4 |
| Powder composition: | 10% by weight Pt; 89% by weight Pd; |
| | 1.0% by weight iodine as PdI₂ |
| Average grain size (Cilas ₅₀): | 2.5 μm |
| BET surface (m²/g): | 1.1 |

### EXAMPLE 4

Solution used: Pd- and Pt tetraamine nitrate solutions (pH=8-10); total noble-metal content: 3.3% by weight.

Weighed portion of powdery PdI₂, for the desired amount of iodine.

Method parameters (Production Alternative 2):

| Predrying temperature: | 150° C. |
|---|---|
| Fuel gas (H₂): | 1300 l/h |
| Total amount of gas: | 5400 l/h reactor gas (including carrier gas |
| | for both aerosolizing units) |
| Lambda (O₂/H₂): | 1.5 |
| Powder composition: | 10% by weight Pt; 89.9% by weight Pd; |
| | 1.0% by weight iodine as PdI₂ |
| Average grain size (Cilas ₅₀): | 0.83 μm |
| BET surface (m²/g): | 3.3 |

### EXAMPLE 5

Solutions used: Nitrate-acidic, Pd- and Pt-containing, aqueous solution (pH=1-3); noble-metal content 6% by weight.

Aqueous PdI₂ solution; 5% by weight relative to I₂; the dosage is adjusted for the desired iodine content.

Method parameters (Production Alternative 4):

| Predrying temperature: | 200° C. |
|---|---|
| Fuel gas (H₂): | 1600 l/h |
| Total amount of gas: | 1600 l/h reactor gas (including carrier gas |
| | for both aerosolizing units) |
| Lambda (O₂/H₂): | 1.3 |
| Powder composition: | 10% by weight Pt; 80% by weight Pd; |
| | 10% by weight iodine as PdI₂ |
| Average grain size (Cilas ₅₀): | 0.89 μm |
| BET surface (m²/g): | 2.1 |

### EXAMPLE 6

Solutions used: Nitrate-acidic, Pd-containing, aqueous solution (pH=1-3); noble-metal content 5.4% by weight.

Aqueous PdI₂ solution; 3% by weight relative to I₂; the dosage is adjusted for the desired iodine content.

Method parameters (production variant 2):

| Predrying temperature: | 200° C. |
|---|---|
| Fuel gas (H₂): | 1600 l/h |
| Total amount of gas: | 5800 l/h reactor gas (including carrier gas |
| | for both aerosolizing units) |
| Lambda (O₂/H₂): | 1.3 |
| Powder composition: | 90% by weight Pd; 10% by weight |
| | iodine as PdI₂ |
| Average grain size (Cilas ₅₀): | 0.96 μm |
| BET surface (m²/g): | 2.2 |

### EXAMPLE 7

Solutions used: Nitrate-acidic, Pd-containing, aqueous solution (pH=1-3); noble-metal content 5% by weight.

Aqueous PdI₂ solution; 1% by weight relative to I₂; the dosage is adjusted for the desired iodine content.

Method parameters (Production Alternative 2):

| Predrying temperature: | 200° C. |
|---|---|
| Fuel gas (H₂): | 800 l/h |
| Total amount of gas: | 5700 l/h reactor gas (including carrier gas |
| | for both aerosolizing units) + 1200 l/h |
| | quenching gas |
| Lambda (O₂/H₂): | 2.9 |
| Powder composition: | 98% by weight Pd; 2% by weight iodine |
| | as PdI₂ |
| Average grain size (Cilas ₅₀): | 2.82 μm |
| BET surface (m²/g): | 1.0 |

### EXAMPLE 8

Solutions used: Nitrate-acidic, Pd-containing, aqueous solution (pH=1-3); noble-metal content 5% by weight

Aqueous PdI₂ solution; 1% by weight relative to I₂; the dosage is adjusted for the desired iodine content.

Method parameters (production Alternative 3):

| | |
|---|---|
| Predrying temperature: | None as there is no predrying |
| Fuel gas (H₂): | 1600 l/h |
| Total amount of gas: | 5500 l/h reactor gas (including carrier gas |
| | for aerosolizing and atomizing units) |
| Lambda (O₂/H₂): | 1.2 |
| Powder composition: | 98% by weight Pd; 2% by weight iodine |
| | as PdI₂ |
| Average grain size (Cilas ₅₀): | 11.4 μm |

### EXAMPLE 9

Solutions used:

1. Nitrate-acidic, Pd-containing, aqueous solution (pH=1-3); noble-metal content 5.2% by weight

2. Tetrachloroauric acid; noble-metal content 2.5% by weight

Aqueous PdI₂ solution; 1% by weight relative to I₂; the dosage is adjusted for the desired iodine content.

Method parameters (Production Alternative 2):

| | |
|---|---|
| Predrying temperature: | 150° C. |
| Fuel gas (H₂): | 1300 l/h |
| Total amount of gas: | 5000 l/h reactor gas (including carrier gas |
| | for both aerosolizing units) |
| Lambda (O₂/H₂): | 1.63 |
| Powder composition: | 88% by weight Pd; 10% by weight Au; |
| | 2% by weight iodine as PdI₂ |
| Average grain size (Cilas ₅₀): | 0.96 μm |

### EXAMPLE 10

a) Production of Pd Particles (Analogously to Comparative Example 1)

Solution used: Nitrate-acidic, Pd-containing, aqueous solution (pH 1-3); noble-metal content 6% by weight

| Method parameters (Production Alternative 1): | |
|---|---|
| Predrying temperature: | 150 ° C. |
| Fuel gas (H₂): | 1600 1/h |
| Total amount of gas: | 5500 1/h |
| Lambda (O₂/H₂): | 1.4 |
| Powder composition: | 100% by weight Pd |
| Average grain size (Cilas ₅₀): | 0.53 μm |
| BET surface (m²/g): | 3 |

b) Doping of the Pd Particles of a) with Iodine (Production Alternative 5):

To this end, 5 g catalyst according to step a) are placed on a glass filter frit with a porosity of D4 and the frit is thermostatted to 50° C.

A volume per hr of 150 ml/h of a 50° C. aqueous solution with a concentration of 0.005 N H₃PO₄/0.0005 N NaI is allowed to trickle over the catalyst in such a manner that the catalyst is evenly wetted. The catalyst is subsequently rinsed several times with deionized [demineralized] water and then dried by suction.

### EXAMPLES FOR THE DIRECT SYNTHESIS OF H₂O₂

The following table shows the operating conditions and results for the direct synthesis of H₂O₂ embodiments, in accordance with the invention (examples 11-21). The iodine-containing noble-metal catalyst was produced by flame pyrolysis and compared with an iodine-free noble-metal catalyst (Comparative Example 3) and with a promoter-free reaction medium and a reaction medium containing bromide and H₂SO₄ was used in Comparative Example 2.

| | Reference example 2: | | | | |
|---|---|---|---|---|---|
| | Example 2 of | | | | |
| Example No. | EP 0 579 109 B1 | Reference example 3 | Example 11 | Example 12 | |
| Apparatus | Trickle-bed autoclave | Trickle-bed autoclave | Trickle-bed autoclave | Trickle-bed autoclave | |
| | with 10.3 mm inside | with 18 mm inside | with 18 mm inside | with 18 mm inside | |
| | diameter and 1.2 m | diameter and 40 cm | diameter and 40 cm | diameter and 40 cm | |
| | length | length | length | length | |
| Catalyst | Suitable catalyst | 147 g flame pyrolysis | 147 g flame pyrolysis | 147 g flame pyrolysis | |
| | 40 g 2% by wt. Pd on | catalyst according to ref. | catalyst according to ex. | catalyst according to ex. | |
| | activated carbon | ex. 1 on Al₂O₃/SiO₂ | 1 on Al₂O₃/SiO₂ (0.1- | 1 on Al₂O₃/SiO₂ (0.1- | |
| | 0.15-0.25 mm | (0.1-0.3 mm) | 0.3 mm) | 0.3 mm) | |
| | | 2.5% by wt. noble metal | 2.5% by wt. noble metal | 2.5% by wt. noble metal | |
| | | 90% by wt. Palladium | 88% by wt. palladium | 88% by wt. palladium | |
| | | 10% by wt. Platinum | 10% by wt. platinum | 10% by wt. platinum | |
| | | | 2% by wt. Iodine | 2% by wt. Iodine | |
| Reaction solution | Liquid to: 0.75 kg/h | Liquid to: 0.1 kg/h | Liquid to: 0.12 kg/h | Liquid to: 0.12 kg/h | |
| | Aqueous: 0.1 molar | Water | Water | Water with stabilizer | |
| | H₂SO₄ | | | 200 mg/l H₃PO₄ | |
| | 0.001 molar NaBr | | | 40 mg/l | |
| | | | | Na-pyrophosphate | |
| | | | | 15 mg/l Na-stannate | |
| Reaction | 60 bar, 52 ° C., | 50 bar (ü), 50° C., | 50 bar (ü), 50° C., | 50 bar (ü), 50° C., | |
| conditions | 5.3% by vol. H₂, | 3.7% by vol. H₂, | 3.7% by vol. H₂, | 3.7% by vol. H₂, | |
| | 60% by vol. O₂, | 20% by vol. O₂, | 20% by vol. O₂, | 20% by vol. O₂, | |
| | remainder N₂ | remainder N₂ | remainder N₂ | remainder N₂ | |
| | 1500 Nl/h, | 250 Nl/h, | 250 Nl/h, | 250 Nl/h, | |
| | no gas recycling | no gas recycling | no gas recycling | no gas recycling | |
| Test time | 8 hours | 20 hours | 20 hours | 20 hours | |
| H₂ conversion | 25-30% | 100% | 54% | 55% | |
| H₂ selectivity | 80% | 0% | 42% | 56% | |
| H₂O₂ | 5% by wt. | 0% by wt. | 2.5% by wt. | 3.4% by wt. | |
| concentration | | | | | |
| achieved | | | | | |
| Test | Example 13 | Example 14 | Example 15 | Example 16 | Example 17 |
| Apparatus | Trickle-bed autoclave | Trickle-bed autoclave | Trickle-bed autoclave | Trickle-bed autoclave | Trickle-bed autoclave |
| | with 18 mm inside | with 18 mm inside | with 18 mm inside | with 18 mm inside | with 18 mm inside |
| | diameter and 40 m | diameter and 40 cm | diameter and 40 cm | diameter and 40 cm | diameter and 40 cm |
| | length | length | length | length | length |
| Catalyst | 147 g flame pyrolysis | 147 g flame pyrolysis | 147 g flame pyrolysis | 147 g flame pyrolysis | 147 g flame pyrolysis |
| | catalyst according to ex. | catalyst according to ex. | catalyst according to ex. | catalyst according to ex. | catalyst according to ex. |
| | 2 on Al₂O₃/SiO₂ (0.1- | 3 on Al₂O₃/SiO₂ (0.1- | 4 on Al₂O₃/SiO₂ (0.1- | 5 on Al₂O₃/SiO₂ (0.1- | 6 on Al₂O₃/SiO₂ (0.1- |
| | 0.3 mm) | 0.3 mm) | 0.3 mm) | 0.3 mm) | 0.3 mm) |
| | 2.5% by wt. noble metal | 2.5% by wt. noble metal | 2.5% by wt. noble metal | 2.5% by wt. noble metal | 2.5% by wt. noble metal |
| | 89% by wt. palladium | 89% by wt. palladium | 89.9% by wt. palladium | 80% by wt. palladium | 90% by wt. palladium |
| | 10% by wt. platinum | 10% by wt. platinum | 10% by wt. platinum | 10% by wt. platinum | 10% by wt. iodine |
| | 0.25% by wt. iodine | 1% by wt. iodine | 0.1% by wt. iodine | 10% by wt. iodine | |
| Reaction solution | Liquid to: 0.12 kg/h | Liquid to: 0.12 kg/h | Liquid to: 0.12 kg/h | Liquid to: 0.12 kg/h | Liquid to: 0.12 kg/h |
| | Water with stabilizer | Water with stabilizer | Water with stabilizer | Water with stabilizer | Water with stabilizer |
| | 200 mg/l H₃PO₄ | 200 mg/l H₃PO₄ | 200 mg/l H₃PO₄ | 200 mg/l H₃PO₄ | 200 mg/l H₃PO₄ |
| | 40 mg/l Na- | 40 mg/l Na- | 40 mg/l Na- | 40 mg/l Na- | 40 mg/l Na- |
| | pyrophosphate | pyrophosphate | pyrophosphate | pyrophosphate | pyrophosphate |
| | 15 mg/l Na-stannate | 15 mg/l Na-stannate | 15 mg/l Na-stannate | 15 mg/l Na-stannate | 15 mg/l Na-stannate |
| Reaction | 50 bar (ü), 50° C., | 50 bar (ü), 50° C., | 50 bar (ü), 50° C., | 50 bar (ü), 50° C., | 50 bar (ü), 50° C., |
| conditions | 3.7% by vol. H₂, | 3.7% by vol. H₂, | 3.7% by vol. H₂, | 3.7% by vol. H₂, | 3.7% by vol. H₂, |
| | 20% by vol. O₂, | 20% by vol. O₂, | 20% by vol. O₂, | 20% by vol. O₂, | 20% by vol. O₂, |
| | remainder N₂ | remainder N₂ | remainder N₂ | remainder N₂ | remainder N₂ |
| | 250 Nl/h, | 250 Nl/h, | 250 Nl/h, | 250 Nl/h, | 250 Nl/h, |
| | no gas recycling | no gas recycling | no gas recycling | no gas recycling | no gas recycling |
| Test time | 20 hours | 20 hours | 20 hours | 20 hours | 20 hours |
| H₂ conversion | 60% | 55% | 68% | 20% | 5% |
| H₂ selectivity | 47% | 54% | 30% | 13% | 10% |
| H₂O₂ | 3.1% by wt. | 3.3% by wt. | 2.3% by wt. | 0.3% by wt. | 0.06% by wt. |
| concentration | | | | | |
| achieved | | | | | |
| Test | Example 18 | Example 19 | Example 20 | Example 21 | |
| Apparatus | Trickle-bed autoclave | Trickle-bed autoclave | Trickle-bed autoclave | Trickle-bed autoclave | |
| | with 18 mm inside | with 18 mm inside | with 18 mm inside | with 18 mm inside | |
| | diameter and 40 m | diameter and 40 cm | diameter and 40 cm | diameter and 40 cm | |
| | length | length | length | length | |
| Catalyst | 147 g flame pyrolysis | 147 g flame pyrolysis | 147 g flame pyrolysis | 147 g flame pyrolysis | |
| | catalyst according to ex. | catalyst according to ex. | catalyst according to ex. | catalyst according to ex. | |
| | 7 on Al₂O₃/SiO₂ (0.1- | 8 on Al₂O₃/SiO₂ (0.1- | 9 on Al₂O₃/SiO₂ (0.1- | 10 on Al₂O₃/SiO₂ (0.1- | |
| | 0.3 mm) | 0.3 mm) | 0.3 mm) | 0.3 mm) | |
| | 2.5% by wt. noble metal | 2.5% by wt. noble metal | 2.5% by wt. noble metal | 2.5% by wt. noble metal | |
| | 98% by wt. palladium | 98% by wt. palladium | 88% by wt. palladium | | |
| | 2% by wt. iodine | 2% by wt. iodine | 10% by wt. gold | | |
| | | | 2% by wt. iodine | | |
| Reaction solution | Liquid to: 0.12 kg/h | Liquid to: 0.12 kg/h | Liquid to: 0.12 kg/h | Liquid to: 0.12 kg/h | |
| | Water with stabilizer | Water with stabilizer | Water with stabilizer | Water with stabilizer | |
| | 200 mg/l H₃PO₄ | 200 mg/l H₃PO₄ | 200 mg/l H₃PO₄ | 200 mg/l H₃PO₄ | |
| | 40 mg/l Na- | 40 mg/l Na- | 40 mg/l Na- | 40 mg/l Na- | |
| | pyrophosphate | pyrophosphate | pyrophosphate | pyrophosphate | |
| | 15 mg/l Na-stannate | 15 mg/l Na-stannate | 15 mg/l Na-stannate | 15 mg/l Na-stannate | |
| Reaction | 50 bar (ü), 50° C., | 50 bar (ü), 50° C., | 50 bar (ü), 50° C., | 50 bar (ü), 50° C., | |
| conditions | 3.7% by vol. H₂, | 3.7% by vol. H₂, | 3.7% by vol. H₂, | 3.7% by vol. H₂, | |
| | 20% by vol. O₂, | 20% by vol. O₂, | 20% by vol. O₂, | 20% by vol. O₂, | |
| | remainder N₂ | remainder N₂ | remainder N₂ | remainder N₂ | |
| | 250 Nl/h, | 250 Nl/h, | 250 Nl/h, | 250 Nl/h, | |
| | no gas recycling | no gas recycling | no gas recycling | no gas recycling | |
| Test time | 20 hours | 20 hours | 20 hours | 20 hours | |
| H₂ conversion | 35% | 30% | 74% | 22% | |
| H₂ selectivity | 50% | 9% | 45% | 40% | |
| H₂O₂ | 2% by wt. | 0.3% by wt. | 3.6% by wt. | 1% by wt. | |
| concentration | | | | | |
| achieved | | | | | |

What is claimed is:

1. A method of producing hydrogen peroxide by direct synthesis comprising:
reacting hydrogen and oxygen in the presence of a heterogeneous, carrier-free or carrier-bound catalyst containing at least one noble-metal and at least one inorganic iodine compound in the presence or absence of a solvent, wherein the amount of iodine content in said catalyst is in a range of 0.01 to 15% by weight based on the weight of said noble-metal.

2. The method according to claim 1, wherein said noble-metal is selected from the group consisting of platinum, silver, gold, palladium and mixtures thereof.

3. The method according to claim 1, wherein the catalyst comprises alloyed or unalloyed forms of said noble-metal.

4. The method according to claim 1, wherein said catalyst comprises palladium iodide or platinum iodide.

5. The method according to claim 1, wherein the catalyst is produced by a spray or flame pyrolysis method comprising;
(i) producing a gas-carried particle stream containing at least one noble-metal and at least one iodine compound in the particles,
(ii) pyrolyzing said particle stream in a spray or flame pyrolysis reactor at a temperature of 500 to 1500° C.,
(iii) separating solid particles formed during step (ii) and, optionally,
(iv) impregnating a catalytic carrier with said solid particles.

6. The method according to claim 5, wherein said particle stream comprises particles containing palladium iodide, platinum iodide or mixtures thereof.

7. The method according to claim 6, wherein said particle stream further comprises at least one precursor for forming an oxide or silicate catalytic carrier.

8. The method according to claim 1, wherein said carrier-free or carrier-bound catalyst further comprises relative to carrier-free catalytic particles:
at least 80% by weight palladium,
0 to 15% by weight gold,
0 to 15% platinum,
0 to 5% by weight silver, and
at least one noble-metal iodide, wherein said noble-metal is selected from the group consisting of Pd, Pt, Au and Ag, and wherein said iodine content catalyst is 0.1 to 10% by weight based on the weight of the noble-metal content.

9. The method according to claim 1, wherein said direct synthesis is conducted in a trickle-bed reactor wherein an aqueous solution containing a stabilizer for hydrogen peroxide trickles over a catalytic fixed bed.

10. A carrier-free or carrier-bound noble-metal catalyst, comprising at least one noble metal and at least one inorganic iodine compound, wherein the amount of iodine content in said catalyst is in a range of 0.01 to 15% by weight based on the weight of said noble-metal.

11. The noble-metal catalyst according to claim 10, wherein said noble-metal catalyst is selected from a group consisting of platinum, silver, gold, palladium and mixtures thereof.

12. The noble-metal catalyst according to claim 10, wherein said noble-metal catalyst comprises noble-metal iodide.

13. The noble-metal catalyst according to claim 12, wherein said noble metal iodide is palladium iodide or platinum iodide.

14. The noble-metal catalyst according to claim 10, wherein said noble-metal catalyst is obtained by spray or flame pyrolysis method comprising:
(i) producing a gas-carried particle stream containing at least one noble-metal and at least one iodine compound in the particles;
(ii) pyrolyzing said particle stream in a spray or flame pyrolysis reactor at a temperature of 500 to 1500° C.,
(iii) separating solid particles formed during step (ii), and, optionally,
(iv) impregnating a catalytic carrier with said solid particles.

15. The noble-metal catalyst according to claim 10, wherein said noble-metal catalyst comprises relative to carrier-free particles:
at least 80% by weight palladium,
0 to 15% by weight gold,
0 to 15% platinum,
0 to 5% by weight silver, and
at least one noble-metal iodide, wherein said noble-metal is selected from the group consisting of Pd, Pt, Au and Ag, and wherein said iodine content in said catalyst is 0.1 to 10% by weight based on the weight of the noble-metal content.

16. The noble-metal catalyst according to claim 14, wherein in step (i), an aqueous or aqueous-organic solution of at least noble-metal compound, at least one iodine compound and, optionally, at least one precursor of an oxidic or silicatic carrier material are sprayed to produce an extremely fine aerosol and, optionally, said formed aerosol is pre-dried.

17. The carrier-bound noble-metal catalyst according to claim 14, wherein said separated solid particles formed in step (ii) are impregnated into a porous oxide, silicate or activated-carbon carrier material.

18. The method according to claim 1, wherein said catalyst to be used is produced by a method comprising:
contacting said noble-metal catalyst with an aqueous solution of an alkali-metal iodide or noble-metal iodide at 20 to 90° C., wherein at least part of the iodide is bound to said noble-metal catalyst and
removing free iodide by washing non-bound iodide out.

19. A carrier-free or carrier-bound noble-metal catalyst, comprising an inorganic iodine compound wherein the iodine content in said catalyst is 001 to 15% by weight is used based on the weight of said noble-metal obtained by the method according to claim 1.
